(19) United States
(12) Patent Application Publication
(10) Pub. No.: US 2026/0300931 A1
(43) Pub. Date: Oct. 1, 2026

(54) MEETING ADJUSTMENT SYSTEM, METHOD, AND PROGRAM

(71) Applicant: NEC Corporation, Tokyo (JP)

(72) Inventors: Shin Norieda, Tokyo (JP); Hisaya Wakayama, Tokyo (JP); Kenichi Takiguchi, Tokyo (JP); Chisho Ueda, Tokyo (JP); Yuto Tsukada, Tokyo (JP)

(73) Assignee: NEC Corporation, Tokyo (JP)

(21) Appl. No.: 19/576,123

(22) Filed: Mar. 24, 2026

(30) Foreign Application Priority Data
Mar. 28, 2025 (JP) 2025-054999

(51) Int. Cl. G06Q 10/1093

(52) U.S. Cl. CPC G06Q 10/1093

(57) ABSTRACT

The meeting adjustment system includes a participant adjustment unit. The participant adjustment unit adjusts participants for a target meeting from among participant candidates based on an evaluation of the participant candidates that is obtained from minutes of meetings previously attended by the participant candidates.

### CROSS-REFERENCE TO RELATED APPLICATIONS

This application is based upon and claims the benefit of priority from the prior Japanese Patent Application No. 2025-054999, filed Mar. 28, 2025, the entire contents of which are incorporated herein by reference.

### BACKGROUND OF THE INVENTION

The present disclosure relates to a meeting adjustment system, a meeting adjustment method, and a meeting adjustment program that adjust participants for a meeting.

Since multiple stakeholders are involved in a meeting, adjustment of participants is important. For example, Patent Literature 1 describes a meeting scheduling system that sets reservations according to schedules of respective participants. The system described in Patent Literature 1 creates a meeting schedule proposal based on available time information of participants who attend the meeting and schedule information before and after the available time, as well as available time information of a meeting room used for the meeting and reservation information before and after the available time.

### Prior Art Documents

### Patent Literatures

[Patent Literature 1] Japanese Patent Application Laid-Open No. 2023-38016

### SUMMARY OF THE INVENTION

In order to make a meeting meaningful, it is preferable that participants can be appropriately adjusted in consideration of characteristics of the meeting. In the system described in Patent Literature 1, participants are adjusted from a viewpoint of whether they can attend the meeting. Therefore, participants that are adjusted are not necessarily participants who can make the meeting meaningful.

Accordingly, an object of the present disclosure is to provide a meeting adjustment system, a meeting adjustment method, and a meeting adjustment program that can adjust participants for a meeting in consideration of characteristics of the meeting.

A meeting adjustment system according to the present disclosure includes a participant adjustment unit configured to adjust participants for a target meeting from among participant candidates based on an evaluation of the participant candidates that is obtained from minutes of meetings previously attended by the participant candidates.

A meeting adjustment method according to the present disclosure includes adjusting participants for a target meeting from among participant candidates based on an evaluation of the participant candidates that is obtained from minutes of meetings previously attended by the participant candidates.

A meeting adjustment program according to the present disclosure causes a computer to execute a participant adjustment process of adjusting participants for a target meeting from among participant candidates based on an evaluation of the participant candidates that is obtained from minutes of meetings previously attended by the participant candidates.

According to the present disclosure, participants for a meeting can be adjusted in consideration of characteristics of the meeting.

### BRIEF DESCRIPTION OF DRAWINGS

FIG. 1 is a block diagram illustrating a configuration example of a meeting adjustment system according to an example embodiment of the present disclosure.

FIG. 2 is a flowchart illustrating an operation example of the meeting adjustment system.

FIG. 3 is an explanatory diagram illustrating an example of meeting adjustment.

FIG. 4 is a block diagram illustrating an overview of the meeting adjustment system according to the present disclosure.

FIG. 5 is a schematic block diagram illustrating a configuration of a computer according to at least one example embodiment.

### DETAILED DESCRIPTION OF THE INVENTION

Hereinafter, example embodiments of the present disclosure will be described with reference to the drawings.

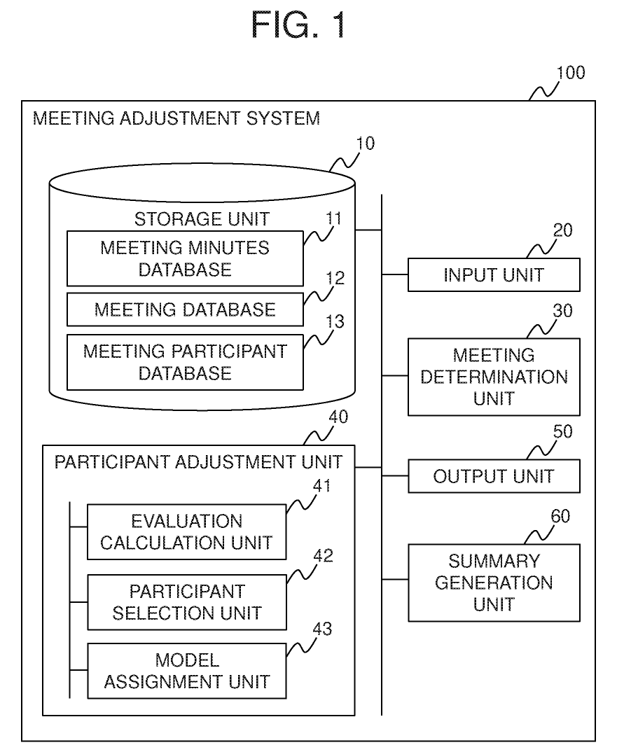

FIG. 1 is a block diagram illustrating a configuration example of a meeting adjustment system according to an example embodiment of the present disclosure. A meeting adjustment system 100 according to the present example embodiment includes a storage unit 10, an input unit 20, a meeting determination unit 30, a participant adjustment unit 40, an output unit 50, and a summary generation unit 60.

The storage unit 10 stores various types of information used for processing by the meeting adjustment system 100. The storage unit 10 may also store various types of information received by the input unit 20 described later. The storage unit 10 may be implemented by a magnetic disk or the like.

The storage unit 10 includes a meeting minutes database 11, a meeting database 12, and a meeting participant database 13.

The meeting minutes database 11 stores minutes of meetings that were held in the past. In the present example embodiment, a case in which the meeting minutes database 11 stores text-based minutes is described. However, the meeting minutes database 11 may store minutes in other forms such as audio or video.

The content of the minutes is arbitrary as long as information that enables identification of content of the meeting is included. For example, the minutes may include a meeting name, a type of meeting, an outline of the meeting, an agenda used in the meeting, participants of the meeting, and date and time of the meeting. However, the content included in the minutes is not limited thereto.

The meeting database 12 stores information relating to meetings. Specifically, the meeting database 12 may store proposal data relating to meetings, such as proposal data of meeting time, proposal data of a meeting agenda, and proposal data of meeting participants. The meeting database 12 may also store data relating to meetings that have been determined. The meeting database 12 may store proposal data received by the input unit 20 described later or data relating to meetings determined by the meeting determination unit 30 described later.

The meeting database 12 may also store various types of information used in a scheduler. For example, the meeting database 12 may store available time slots for scheduling meetings and availability information of meeting rooms.

The meeting participant database 13 stores information relating to participant candidates for meetings. For example, the meeting participant database 13 may store business information of participant candidates, position information, and information relating to decision-making authority. The meeting participant database 13 may also store information spoken by participant candidates in past meetings.

The input unit 20 receives input of various types of information for adjusting participants for a target meeting. For example, the input unit 20 may receive input of information stored in the respective databases included in the storage unit 10.

The meeting determination unit 30 determines content of a target meeting. Specifically, the meeting determination unit 30 determines a required meeting time and a meeting agenda necessary for the target meeting. For example, the meeting determination unit 30 may determine the required meeting time from proposal data of the meeting agenda.

The method for determining the required meeting time is arbitrary. For example, the meeting determination unit 30 may estimate the required meeting time using a model that predicts meeting time based on past minutes, or may extract meeting time of a past meeting that has an agenda or discussion content similar to that of the target meeting and calculate the meeting time of the target meeting based on the extracted meeting time, for example, by using an average time.

The method for determining the meeting agenda is also arbitrary. For example, the meeting determination unit 30 may delete low-priority agenda items from proposal data of meeting participants and meeting time and generate a new agenda. Alternatively, the meeting determination unit 30 may extract minutes that have a similar agenda and delete agenda items that are estimated not to have a causal relationship with a conclusion, and generate a new agenda. The meeting determination unit 30 may further predict the meeting time based on the generated new agenda.

The meeting determination unit 30 may determine that the meeting is to be conducted based on content that was proposed in advance. When it is assumed that all target meetings are conducted according to predetermined content, the meeting adjustment system 100 may not include the meeting determination unit 30.

The participant adjustment unit 40 adjusts participants for a target meeting. Specifically, the participant adjustment unit 40 adjusts participants for the target meeting from among participant candidates based on evaluations of the participant candidates that are obtained from minutes of meetings previously attended by the participant candidates.

The participant adjustment unit 40 includes an evaluation calculation unit 41, a participant selection unit 42, and a model assignment unit 43.

The evaluation calculation unit 41 calculates an evaluation of participant candidates for a meeting from minutes of the meeting. A method for calculating the evaluation is arbitrary, and one or more predetermined methods are used to calculate a higher evaluation for participant candidates who are determined to be suitable for participation in the target meeting. The calculated evaluation may be referred to as a degree of contribution to the meeting.

For example, the evaluation calculation unit 41 may identify, from the minutes, participants of meetings that are similar to the target meeting and calculate higher evaluations for participant candidates who are extracted more frequently, that is, participant candidates who have attended such meetings more often. The evaluation calculation unit 41 may also calculate higher evaluations for participant candidates whose participation is regarded as preferable based on content of the minutes, participant candidates having a predetermined position, or participant candidates having decision-making authority.

The evaluation calculation unit 41 may also calculate higher evaluations for participant candidates who are determined from the minutes to perform smooth communication in the meeting, for example, participant candidates who have many favorable statements or whose discussions are active.

Further, in addition to the minutes, the evaluation calculation unit 41 may calculate higher evaluations for participant candidates who have more prior knowledge or for participant candidates who have a higher degree of understanding of the meeting. The evaluation calculation unit 41 may also refer to the meeting participant database 13 and calculate the evaluation based on personal information of the participant candidates. For example, the evaluation calculation unit 41 may calculate a higher evaluation for a participant candidate who holds a position having decision-making authority.

The participant selection unit 42 selects participants for the target meeting from among the participant candidates based on the evaluations of the participant candidates and schedules of the participant candidates. Specifically, the participant selection unit 42 may determine a combination of participants, among participant candidates who are available during a time period in which the meeting is held, that maximizes a total of the evaluations.

Further, the participant selection unit 42 may divide the time period in which the meeting is held for each agenda item and determine, for each divided time period, a combination of participants, among participant candidates who are available during the divided time period, that maximizes a total of the evaluations. In order to suppress frequent replacement of participants for each time period, the participant selection unit 42 may preferentially select participant candidates who are available continuously. By dividing the time period of the meeting in this manner, even when there is a participant candidate who can participate only during part of the meeting and has decision-making authority for a specific agenda item, the participant candidate can participate in the meeting.

It is also assumed that, during a time period of the target meeting, another meeting may be scheduled unexpectedly and rescheduling may be required. In such a case, the participant selection unit 42 may refer to the meeting database 12 or the like to identify available time slots for scheduling the meeting. The participant selection unit 42 may then select participants again for the identified available time slots.

When no available time slots for scheduling the meeting can be identified, the participant selection unit 42 may determine which of overlapping meetings, that is, the target meeting and another meeting, should be rescheduled. In such a case, the participant selection unit 42 may determine priority based on participants of the meetings, agendas of the meetings, types of the meetings, or the like. For a meeting that is determined to be rescheduled, the participant selection unit 42 may instruct the meeting determination unit 30 to shorten the meeting based on the agenda, for example, by deleting unnecessary agenda items in order to create available time.

When rescheduling the meeting, the participant selection unit 42 may notify participants of the rescheduled meeting of a reason for rescheduling or an apology. The participant selection unit 42 may cause an LLM, not illustrated, to generate text used for the notification of the reason or the apology.

The model assignment unit 43 assigns an AI as a participant according to content of the target meeting. Examples of the AI include a large language model that operates on a computer. For example, the model assignment unit 43 may assign an AI as a participant to a meeting that requires provision of objective information or facilitation of discussion. An AI to be assigned according to content of the meeting may be predetermined. An avatar or the like may be used in order to cause the AI to behave like an actual participant.

By explicitly assigning the AI as a participant in this manner, it becomes possible to reduce preparation burden and psychological burden of participants prior to the meeting.

The output unit 50 outputs a result of adjustment of the meeting. The output unit 50 may notify selected participants of information of the meeting and a request to participate in the meeting, for example, by electronic mail. The output unit 50 may also register information of the determined meeting in a scheduler that can be viewed by participants.

The summary generation unit 60 generates a summary of an ongoing meeting. Specifically, when a participant who participates only during part of the meeting is assigned to the target meeting, the summary generation unit 60 generates a summary of a portion of the meeting that proceeds during a time period in which the participant does not participate. By including the summary generation unit 60, even when a participant is assigned to participate only during part of the meeting, it becomes possible to assist the participant in understanding an overall picture of the meeting.

The input unit 20, the meeting determination unit 30, the participant adjustment unit 40, specifically the evaluation calculation unit 41, the participant selection unit 42, and the model assignment unit 43, the output unit 50, and the summary generation unit 60 are implemented by a processor of a computer that operates according to a program, for example, a CPU (Central Processing Unit).

For example, the program is stored in the storage unit 10 of the meeting adjustment system 100, and the processor reads the program and operates as the input unit 20, the meeting determination unit 30, the participant adjustment unit 40, specifically the evaluation calculation unit 41, the participant selection unit 42, and the model assignment unit 43, the output unit 50, and the summary generation unit 60 in accordance with the program. Functions of the meeting adjustment system 100 may also be provided in a SaaS (Software as a Service) format.

The input unit 20, the meeting determination unit 30, the participant adjustment unit 40, specifically the evaluation calculation unit 41, the participant selection unit 42, and the model assignment unit 43, the output unit 50, and the summary generation unit 60 may each be implemented by dedicated hardware. Some or all components of each device may be implemented by general-purpose or dedicated circuitry, a processor, or a combination thereof. These may be configured by a single chip or by a plurality of chips connected via a bus. Some or all components of each device may be implemented by a combination of the circuitry described above and a program.

When some or all components of the meeting adjustment system 100 are implemented by a plurality of information processing apparatuses or circuitry, the plurality of information processing apparatuses or circuitry may be arranged in a centralized manner or in a distributed manner. For example, the information processing apparatuses or circuitry may be implemented in a form in which they are connected via a communication network, such as a client-server system or a cloud computing system.

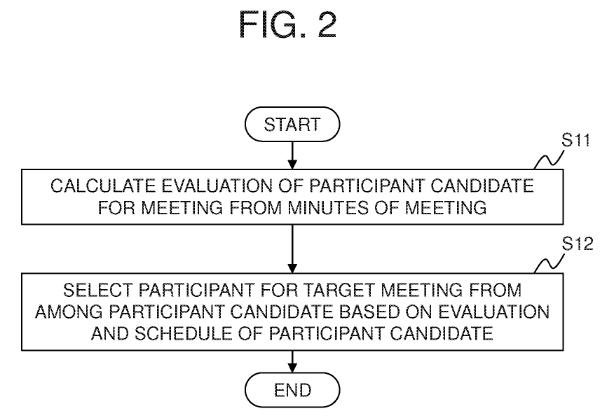

Next, an operation example of the meeting adjustment system 100 according to the present example embodiment will be described. FIG. 2 is a flowchart illustrating an operation example of the meeting adjustment system 100.

The evaluation calculation unit 41 calculates an evaluation of participant candidates for the meeting from the minutes of the meeting (Step S11). The participant selection unit 42 selects participants for the target meeting from among the participant candidates based on the evaluations of the participant candidates and schedules of the participant candidates (Step S12).

As described above, in the present example embodiment, the participant adjustment unit 40 adjusts participants for the target meeting from among participant candidates based on evaluations of the participant candidates that are obtained from minutes of meetings previously attended by the participant candidates. Therefore, participants for a meeting can be adjusted in consideration of characteristics of the meeting.

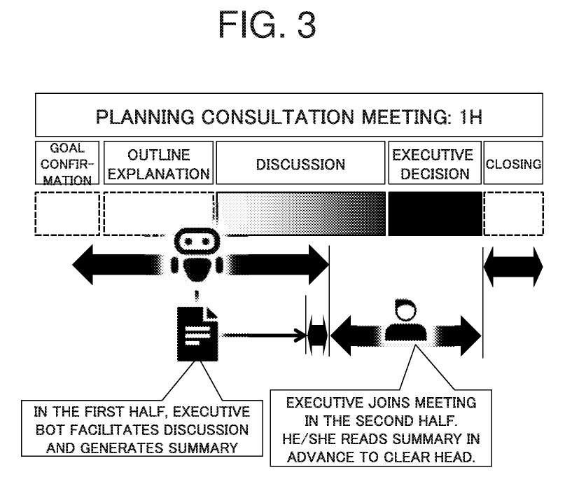

Next, a specific example of meeting adjustment using the meeting adjustment system 100 according to the present example embodiment will be described. FIG. 3 is an explanatory diagram illustrating an example of meeting adjustment. In the example illustrated in FIG. 3, it is assumed that the target meeting is a planning consultation meeting, a meeting time is set to one hour, and agenda items are set to goal confirmation, outline explanation, discussion, executive decision, and closing.

The participant selection unit 42 decomposes the meeting into individual tasks based on the agenda and redefines a required time period for executives who are participants. As a result, it becomes possible to invite the executives as participants only during a time period of the executive decision.

Further, by assigning an LLM or the like as a participant by the model assignment unit 43, it becomes possible to cause the LLM to facilitate the meeting. In the example illustrated in FIG. 3., by assigning an executive robot as the LLM in a first half of the meeting, the executive robot can facilitate discussion and generate a summary for the executive. As a result, even when the executive participates in the meeting only from a latter half, the executive can grasp an overall picture of the meeting by reading the summary in advance.

The meeting adjustment system 100 may also optimize schedules, such as investment consultation or one-on-one rescheduling, based on constraints such as planned participants, deadlines, and intentions of executives.

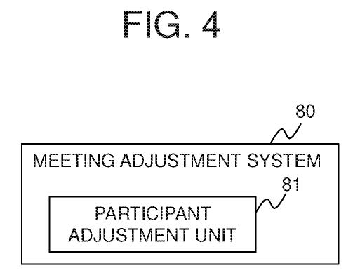

Next, an overview of the present disclosure will be described. FIG. 4 is a block diagram illustrating an overview of a meeting adjustment system according to the present disclosure. A meeting adjustment system 80 (for example, the meeting adjustment system 100) includes a participant adjustment unit 81 (for example, the participant adjustment unit 40) configured to adjust participants for a target meeting from among participant candidates based on an evaluation of the participant candidates that is obtained from minutes of meetings previously attended by the participant candidates.

With such a configuration, participants for a meeting can be adjusted in consideration of characteristics of the meeting.

The participant adjustment unit 81 may include an evaluation calculation unit (for example, the evaluation calculation unit 41) configured to calculate an evaluation of participant candidates for a meeting from minutes of the meeting, and a participant selection unit (for example, the participant selection unit 42) configured to select participants for the target meeting from among the participant candidates based on the evaluations of the participant candidates and schedules of the participant candidates.

Specifically, the participant selection unit may determine a combination of participants, among participant candidates who are available during a time period in which the target meeting is held, that maximizes a total of the calculated evaluations.

The participant selection unit may divide the time period in which the meeting is held for each agenda item and determine, for each divided time period, a combination of participants, among participant candidates who are available during the divided time period, that maximizes a total of the evaluations.

The meeting adjustment system 80 may further include a summary generation unit (for example, the summary generation unit 60) configured to generate a summary of a portion of the meeting that proceeds during a time period in which a participant assigned to participate only in part of the meeting does not participate.

The participant selection unit may assign an AI (for example, an LLM or an avatar) to a participant candidate according to content of the target meeting.

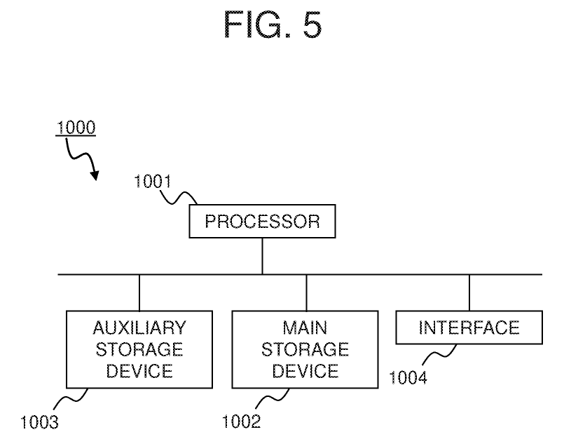

FIG. 5 is a schematic block diagram illustrating a configuration of a computer according to at least one example embodiment. A computer 1000 includes a processor 1001, a main storage device 1002, an auxiliary storage device 1003, and an interface 1004. A computer that executes a mathematical programming solver, an annealing machine, or a simulator may be connected to the computer 1000.

The meeting adjustment system 80 described above is implemented in the computer 1000. Operations of the respective processing units described above are stored in the auxiliary storage device 1003 in the form of a program, that is, a meeting adjustment program. The processor 1001 reads the program from the auxiliary storage device 1003 into the main storage device 1002 and executes processing according to the program.

In at least one example embodiment, the auxiliary storage device 1003 is an example of a non-transitory tangible medium. Other examples of the non-transitory tangible medium include a magnetic disk, a magneto-optical disk, a CD-ROM, a DVD-ROM, and a semiconductor memory connected via the interface 1004. When the program is distributed to the computer 1000 via a communication line, the computer 1000 that receives the distribution may expand the program into the main storage device 1002 and execute the processing described above.

The program may implement part of the functions described above. The program may also be a so-called differential file that implements the functions described above in combination with another program that is already stored in the auxiliary storage device 1003.

Although the invention has been described above with reference to example embodiments and examples, the invention is not limited to the above example embodiments and examples. Various modifications that can be understood by those skilled in the art may be made within the scope of the invention.

1. A meeting adjustment system comprising:
a memory storing instructions; and
one or more processors configured to execute the instructions to adjust participants for a target meeting from among participant candidates based on an evaluation of the participant candidates that is obtained from minutes of meetings previously attended by the participant candidates.

2. The meeting adjustment system according to claim 1, wherein the processor is configured to execute the instructions to:
calculate an evaluation of participant candidates for a meeting from minutes of the meeting; and
select participants for the target meeting from among the participant candidates based on the evaluation of the participant candidates and schedules of the participant candidates.

3. The meeting adjustment system according to claim 2,
wherein the processor is configured to execute the instructions to determine a combination of participants, among participant candidates who are available during a time period in which the target meeting is held, that maximizes a total of the calculated evaluations.

4. The meeting adjustment system according to claim 2,
wherein the processor is configured to execute the instructions to divide a time period in which the meeting is held for each agenda item and determine, for each divided time period, a combination of participants, among participant candidates who are available during the divided time period, that maximizes a total of the evaluations.

5. The meeting adjustment system according to claim 4,
wherein the processor is configured to execute the instructions to generate a summary of a portion of the meeting that proceeds during a time period in which a participant assigned to participate only in part of the meeting does not participate.

6. The meeting adjustment system according to claim 2,
wherein the processor is configured to execute the instructions to assign an AI to a participant candidate according to content of the target meeting.

7. A meeting adjustment method comprising:
adjusting participants for a target meeting from among participant candidates based on an evaluation of the participant candidates that is obtained from minutes of meetings previously attended by the participant candidates.

8. The meeting adjustment method according to claim 7, comprising:
calculating an evaluation of participant candidates for a meeting from minutes of the meeting; and
selecting participants for the target meeting from among the participant candidates based on the evaluation of the participant candidates and schedules of the participant candidates.

9. A non-transitory computer readable information recording medium storing a meeting adjustment program, when executed by a processor, that performs a method for
adjusting participants for a target meeting from among participant candidates based on an evaluation of the participant candidates that is obtained from minutes of meetings previously attended by the participant candidates.

10. The non-transitory computer readable information recording medium according to claim 9, wherein the meeting adjustment program performs a method for:
calculating an evaluation of participant candidates for a meeting from minutes of the meeting; and
selecting participants for the target meeting from among the participant candidates based on the evaluation of the participant candidates and schedules of the participant candidates.
